(19) United States
(12) Patent Application Publication
(10) Pub. No.: US 2014/0142723 A1
(43) Pub. Date: May 22, 2014

(54) AUTOMATIC CONTROL SYSTEM

(71) Applicants: HONDA MOTOR CO., LTD., Tokyo (JP); RiB Laboratory, Inc., Shiga Prefecture (JP)

(72) Inventors: Setsuro MORI, Shiga Perfecture (JP); Keiichi ITANO, Shiga Perfecture (JP); Toshikazu KARUBE, Saitama Prefecture (JP); Tsuyoshi EGUCHI, Saitama Prefecture (JP); Takehiro HORIGOME, Saitama Prefecture (JP)

(73) Assignees: HONDA MOTOR CO., LTD., Tokyo (JP); RiB Laboratory, Inc., Shiga Prefecture (JP)

(21) Appl. No.: 14/067,069

(22) Filed: Oct. 30, 2013

(30) Foreign Application Priority Data
Nov. 22, 2012 (JP) 2012-255984

(51) Int. Cl. G05B 19/042

(52) U.S. Cl. CPC G05B 19/0421
USPC 700/3

(57) ABSTRACT

An automatic control system synchronizes and controls a control target while preventing unnecessary signal processing. The system includes a slave station that is connected to the control target, a master station that is connected to a control unit for controlling the control target, a contact point information collection and distribution device that collects and distributes a series of contact point information communicated at a predetermined communication cycle, and communication lines connecting between the master and slave stations via the contact point information collection and distribution device. The contact point information collection and distribution device collects and distributes the series of contact point information in synchronization with all the communication lines under the control of the control unit. The control unit compares the collected contact point information with past contact point information and assumes as true in a case of matching, and controls by true contact point information.

### FIELD OF THE INVENTION

The present invention relates to an automatic control system.

### DESCRIPTION OF THE RELATED ART

With an appliance for performing automatic control of transportation means such as an automobile, a train, an airplane, a ship, a spaceship or the like, a robot, a manufacturing device, a management device, or the like, the state of an appliance which is a control target is monitored by a control unit by connecting the control target and the control unit by an electrical wire (a wire), and the operation of the control target is controlled. As many electrical wires as the number of states (contact point information) to be controlled and monitored between the control unit and the control target are required, and the structure is complicated to the extent, thereby increasing the manufacturing cost.

Accordingly, a method of performing data communication by using a fewer number of electrical wires as the signal lines by serial communication or the like, and performing various kinds of control has been invented and put to practical use. Particularly, with a control system for vehicle control, machine control or the like, such as a relay connection unit or an electronic control unit described in JP 2008-5290 A, signals indicating the contact point information are multiplexed by using a communication control IC for vehicle LAN for performing transmission and reception of messages that is compliant with communication standards such as CAN (Controller Area Network) or FlexRay (a registered trademark of Daimler Chrysler AG) to thereby control a large number of control targets by a small number of signal lines.

In addition, the vehicle LAN is hierarchically divided into groups, and a gateway is arranged at a connection portion of an upper vehicle LAN and a lower vehicle LAN. Furthermore, with respect to the vehicle LAN, error check is performed by communicating, at the same time, information of a redundant item for determining whether a message to be communicated is accurate, for example, and a message for which communication failure has occurred is discarded. Accordingly, occurrence of control failure due to a message which has been changed by communication failure may be prevented in advance.

FIG. 7 is a diagram showing an example of a conventional automatic control system 90. In FIG. 7, the reference numeral 91 denotes a control target, the reference numeral 92 denotes a slave station to which the control target 91 is to be connected, the reference numeral 93 denotes a master station provided with a control unit 94 for controlling the control target 91, the reference numeral 95 denotes a relay station, existing between the master station 93 and the slave station 92, for relaying contact point information about the control target 91, the reference numeral 96 denotes a first communication line, the reference numeral 97 denotes a second communication line, the reference numerals 93a and 95a denote communication units for transmitting and receiving the contact point information via the first communication line 96, the reference numerals 95b and 92a denote communication units for transmitting and receiving the contact point information via the second communication line 97, the reference numeral 92b denotes an input/output port for storing the contact point information transmitted and received by the communication unit 92a and inputting/outputting the contact point information to/from the control target 91, the reference numeral 93b denotes a dual port memory (hereinafter referred to as DPM) for storing the contact point information transmitted and received by the communication unit 93a, and the reference numeral 95c denotes a DPM for storing the contact point information transmitted and received by the communication units 95a and 95b.

Additionally, the control target 91 includes a motor 91a, a rotary encoder 91b provided to the motor 91a, and a switch 91c, for example.

According to the automatic control system 90 configured in the above manner, the contact point information transmitted from the control unit 94 to the motor 91a is written to the DPM 93b, and then, the contact point information stored in the DPM 93b is transmitted by the communication unit 93a to the communication unit 95a of the relay station 95 via the first communication line 96 and is written to the DPM 95c. Also, the contact point information written to the DPM 95c is transmitted by the communication unit 95b to the communication unit 92a of the slave station 92 via the second communication line 97 and is written to the input/output port 92b to be output to the motor 91a.

Similarly, the contact point information to be input to the input/output port 92b from the rotary encoder 91b or the switch 91c is transferred to the DPM 93b by communication using the second communication line 97 and the first communication line 96 and is input to the control unit 94, and the control unit 94 is thereby enabled to control the motor 91a according to the state of each of units 91b and 91c.

However, according to the conventional automatic control system 90, the update cycle (the communication cycle) of the contact point information transmitted and received by the communication units 95b, 92a, 93a and 95a is slower than the cycle of control by the control unit 94, and thus, the control unit 94 is not able to sufficiently fulfill its capacity. That is, the control unit 94 is able to detect the state of the control target 91 only at least after a time longer than the slowest communication cycle of the communication units 95b, 92a, 93a and 95a has elapsed, and there is a long wait time for the control unit 94, and thus, the control unit 94 performs unnecessary calculation process to that extent and unnecessarily increases the power consumption.

In addition, the cycle by which the control unit 94 is able to obtain the updated contact point information is affected by the number of relay stations 95 or the timing of the control unit 94 accessing the DPM 93b, and there is an issue that, since the length of delay time by which the contact point information of the control target 91 may be detected is not constant, temporally accurate control cannot be performed.

Furthermore, in the case an automatic control logic for counting the pulse of the rotary encoder 91b as the contact point information is built, for example, it is conceivable that unnecessary pulses are counted or that there are uncounted pulses due to occurrence of a communication error. To cope with such a communication error, it is conceivable to perform error check for each communication using each of communication lines 96 and 97, but then, the influence of communication delay due to the error check may become significant.

On the other hand, as one effective error check method, error check by so-called double collation of checking, at the time of the contact point information changing, whether the information is changed to the latest information two times in a row is performed. However, as in the example shown in FIG. 7, in the case communication at different speeds is being relayed, contact point information with an error may be communicated two times in a row depending on the timing of the relayed communication, and communication failure may not be removed even if the double collation is performed.

Accordingly, conventionally, the communication speeds of the communication units 95b, 92a, 93a and 95a are increased as much as possible to secure synchrony of control by the control unit 94. That is, to transmit and receive a contact point signal that changes at a speed of about several tens to several hundreds kHz, a LAN capable of high-speed communication at a sufficient speed of several Mbps to 1 Gbps, for example, may be introduced, and pseudo-simultaneity may be achieved. However, it is inevitable that if the communication speed by LAN is increased, the cost for introducing the LAN is increased to that extent.

In addition, these days, many microcomputers used as the control unit include a port that is compliant with SPI (Serial Peripheral Interface: a communication standard proposed by Motorola) or I2C (I-squared-C: a communication standard proposed by Philips), a UART (Universal Asynchronous Receiver Transmitter) port, and an isochronous serial bus interface, and simplification using these is desired.

### SUMMARY OF THE INVENTION

The present invention has been made in view of the circumstances described above, and its object is to provide an automatic control system, a contact point information collection and distribution device, and a slave station of the automatic control system that are capable of synchronizing and controlling a control target while preventing unnecessary signal processing.

To solve the problem described above, a first invention provides an automatic control system including a slave station that is connected to a control target, a master station that is connected to a control unit for controlling the control target, a contact point information collection and distribution device, existing between the master station and the slave station, that collects and distributes a series of contact point information communicated at a predetermined communication cycle, and a plurality of communication lines that connect between the master station and the slave station via at least one contact point information collection and distribution device, wherein the contact point information collection and distribution device performs collection and distribution of the series of contact point information in synchronization with all the communication lines under the control of the control unit, and wherein the control unit makes the contact point information collection and distribution device perform collection and distribution of the series of contact information in synchronization and compares contact point information collected via the contact point information collection and distribution device with past contact point information collected in a previous communication cycle and assumes as true in a case of matching, and performs control by true contact point information.

According to the automatic control system, the master station transmits and receives the contact point information to/from the contact point information collection and distribution device, and also, transmits and receives a series of contact point information to the slave station at a predetermined communication cycle by communication via the contact point information collection and distribution device, and thus, update of a series of contact point information is completed at both the master station and the slave station at every predetermined communication cycle.

Additionally, the contact point information in the present invention means bit information indicating, for example, a contact point for performing on/off control of an actuator of the control target, and a bit signal indicating the on/off state of a sensor or a switch of the control target, and means a signal having two values, high and low, or a signal having three values, high, low and open. This contact point information is optimally bit information for controlling each control target installed on a mobile body such as a vehicle, but it is needless to say that, even if the contact point information is any of various types of bit information used in an automatic control system of other FA devices and the like, application to any communication system that performs collection and distribution of a series of bit information in a predetermined communication cycle is possible.

Since the control unit compares contact point information collected by communication with past contact point information collected in a previous communication cycle and assumes the contact point information to be true in the case of matching, and thereby performs control by the contact point information, the control target may be controlled after the accuracy of the communicated contact point information is checked, and the operation is reliable. That is, comparison of pieces of contact point information is performed across communication cycles, and this is a method of checking that the same contact point information is received two times in a row (hereinafter referred to as double collation). Communication failure occurring due to an external disturbance such as noise rarely, or realistically never, exerts the same influence on the same contact point information across communication cycles. Accordingly, erroneous control based on communication failure may be practically eliminated by the double collation.

Also, the contact point information used in the automatic control by the control unit is updated being delayed by the amount of a known delay time that can be calculated based on a predetermined communication cycle, and thus, the control unit is capable of performing synchronous control, and the reliability of control is improved to that extent. In addition, according to the double collation, the contact point information communicated over a plurality of communication lines may be checked by the control unit performing the comparison just once, and thus, the signal processing load on the control unit may be suppressed to the minimum.

The control unit is an arithmetic processing unit of a one-chip microcomputer, for example, and communication using the communication lines is performed by a serial communication port that is generally embedded in the one-chip microcomputer, for example. This serial communication port is a contact point information transmitting and receiving unit that performs serial communication by any of the serial bus interface such as SPI or I2C, the isochronous serial interface, UART compliant with the RS-232C standard, or by a token passing method. Moreover, in this case, the master station is the one-chip microcomputer itself, and the master station includes the contact point information transmitting and receiving unit (the serial communication port) that is connected to the control unit configured from the arithmetic processing unit inside the master station.

Also, the control unit is configured so as to be capable of executing a sequence control program and the like, for example, for automatically controlling the control target. Furthermore, the control unit preferably performs transmission and reception of a series of contact point information by serial communication, and the number of signal lines may thereby be reduced, and miniaturization of the package as one-chip and simplification of wiring may be achieved.

With the serial communication that is performed between the control unit and the contact point information collection and distribution device of the master station, it is conceivable to achieve synchrony with respect to all the communication lines by the contact point information collection and distribution device transmitting a transfer preparation completion signal indicating transfer preparation completion of the contact point information that is to be relayed to the master station, and starting transmission and reception of the contact point information when the transfer preparation completion signal is received by the master station. However, the synchrony may also be achieved by the master station intermittently transmitting transfer start timing signals to the contact point information collection and distribution device, and the contact point information collection and distribution device starting transmission and reception of the contact point information according to reception of the transfer start timing signal. Alternatively, it is also possible to omit the signal mentioned above, and when the master station starts transmission of a serial signal of the contact point information to the contact point information collection and distribution device, the contact point information collection and distribution device may start transmission and reception of the contact point information to/from the slave station in synchronization with the start of reception of the serial signal.

Furthermore, the communication to be performed between the contact point information collection and distribution device and the slave station may be serial communication by the serial bus interface such as SPI or I2C, the isochronous serial interface, or UART compliant with the RS-232C standard, but in the case of performing collection and distribution of the contact point information of a mobile body, wire saving is preferably achieved by performing voltage superimposition (PLC: Power Line Communications) and using the communication line as the power line (common use).

Normally, the speed of the arithmetic processing for performing automatic control by the control unit is sufficiently higher than the communication cycle using the communication line, and the control unit does not require the capacity to perform high-speed processing, and can thus be manufactured at a cost lower to the extent. Or, the control unit may perform automatic control of the control target and other arithmetic processing in parallel so that its arithmetic processing capacity is effectively used. In any case, by performing automatic control in synchronization with the communication cycle of the contact point information collection and distribution device, necessary and sufficient automatic control processing may be performed.

The control unit includes a first buffer for storing the contact point information received in the previous communication cycle, and a second buffer for updating and storing the contact point information when the contact point information that is received in the current communication cycle is compared with the previous contact point information stored in the first buffer and is assumed to be true in the case of matching, wherein in a case the control target is to be controlled based on the contact point information stored in the second buffer, since the contact point information received in the previous communication cycle is recorded in the first buffer, the contact point information recorded in the first buffer and the contact point information currently received may be compared, and that the same latest contact point information is received two times in a row may be easily determined in the case of matching, and the value of the contact point information may be relied upon as being the true value.

Furthermore, since the contact point information which is confirmed to be the accurate value by the matching is stored in the second buffer, highly reliable automatic control may be easily performed by performing control based on the contact point information stored in the second buffer. Checking of the matching is signal processing that may be easily performed, and by performing the process by software by the arithmetic processing unit, the hardware structure maybe simplified, and the time spent by the control unit waiting for update of the contact point information by communication may be effectively used. However, the process may also be performed by hardware by using a comparator, and the arithmetic processing load on the arithmetic processing unit may be reduced as much as possible. In either way, the control unit is to control a plurality of serial communication tasks, but a great processing load is not applied on the arithmetic processing unit.

In this invention, the contact point information collection and distribution device may include contact point information transmitting and receiving units existing between the slave station and the master station and connected to the communication lines and being for transmitting and receiving a series of contact point information in a predetermined communication cycle, a relay buffer for storing contact point information which has been transmitted or received, and a communication cycle adjustment unit for synchronizing a communication cycle of each communication line with control by the control unit.

With the contact point information collection and distribution device described above, each contact point information transmitting and receiving unit transmits and receives a series of contact point information in a predetermined communication cycle, and thus, the contact point information stored in the relay buffer may be updated to the latest information in the predetermined communication cycle. In addition, the communication cycle adjustment unit synchronizes the communication cycle of each communication line with the control by the control unit, and thus, the contents of the relay buffer is updated to the latest contact point information at every communication cycle.

The contact point information transmitting and receiving unit is any of serial communication ports including the serial bus interface such as SPI or I2C, the isochronous serial interface, and UART compliant with the RS-232C standard, and a serial communication port that performs communication by the token passing method.

Moreover, the communication cycle adjustment unit may adopt various methods to control transmission and reception of the contact point information by the contact point information transmitting and receiving unit and achieve synchronization of the communication cycle, but the synchronization is preferably achieved by transmission and reception, with the master station, of a transfer permission signal permitting transfer, a transfer preparation completion signal indicating that data on the slave station side to be transferred is ready, a transfer completion signal indicating that transfer of data on the master station side to be transferred is completed, and the like.

That is, for example, the communication cycle adjustment unit causes the contact point information transmitting and receiving unit on the slave station side to receive the contact point information from the slave station when the transfer permission signal is received from the master station and causes the contact point information to be stored in the relay buffer, and then, outputs the transfer preparation completion signal to the master station side, and then, causes the contact point information transmitting and receiving unit on the master station side to perform transmission and reception of the contact point information with the master station and causes the relay buffer to store the contact point information, and causes the contact point information transmitting and receiving unit on the slave station side to transmit the contact point information from the master station after the transfer completion signal from the master station side is received.

Accordingly, the contact point information that is to be received by the master station is first received via the communication line on the slave station side, and then, transmission and reception of the contact point information is performed by performing communication with the master station, and when reception of the contact point information from the master station side is completed, the contact point information is transmitted via the communication line on the slave station side, and thus, synchronization may be achieved between the master station and the slave station with respect to the contact point information by the communication in one communication cycle.

However, the communication cycle adjustment unit may also simultaneously start communication by the contact point information transmitting and receiving units on the master station side and the slave station side using the contact point information stored in the relay buffer at the time of start of the communication cycle, and may update the contact point information in the relay buffer at the time of end of the communication cycle. In this case, the contact point information is updated with a delay of one communication cycle with every intervening contact point information collection and distribution device, but since the delay time is known, automatic control taking the delay time into account may be appropriately performed.

In any case, the contact point information collection and distribution device transmits and receives a series of contact point information in a predetermined communication cycle, and thus, the contact point information that is transmitted and received may be updated in synchronization in each predetermined communication cycle.

In this invention, the slave station may include an input unit, connected to a control target, for inputting contact point information obtained from the control target, a contact point information transmitting and receiving unit for transmitting and receiving a series of contact point information in a predetermined cycle by transmitting the contact point information input from the input unit to a communication line and receiving, from a communication line, contact point information from a master station connected to a control unit for controlling the control target, and an output unit for outputting the contact point information to the control target when the contact point information received in the communication cycle is compared with a series of contact point information received in a previous communication cycle and is assumed to be true in a case of matching.

The control unit may obtain the contact point information of the control target by the contact point information input from the input unit being transmitted to the master station side via the contact point information transmitting and receiving unit, and the control target may be operated according to the contact point information from the control unit by the contact point information from the control unit being received via the contact point information transmitting and receiving unit and being output by the output unit to the control target. Also, since the contact point information that is transmitted and received by the contact point information transmitting and receiving unit is updated at every predetermined communication cycle, the control unit may perform synchronization control on the control target, and may control accurate response time, and thus, the reliability of automatic control is improved to that extent.

Furthermore, since the output unit assumes the contact point information to be true when the contact point information received in the communication cycle is compared with a series of contact point information received in a previous communication cycle and is found to match, correct contact point information is output to the control target after the accuracy of the received contact point information is confirmed, and thus, operation failure due to communication failure may be prevented.

The contact point information transmitting and receiving unit is any of serial communication ports including the serial bus interface such as SPI or I2C, the isochronous serial interface, and UART compliant with the RS-232C standard, and a serial communication port that performs communication by the token passing method.

As described above, according to the present invention, the control target may be controlled while being synchronized with the same cycle as the communication cycle, and thus, unnecessary arithmetic processing is not performed. That is, increase in the power consumption due to unnecessary arithmetic processing is prevented, and the arithmetic processing load on the control unit may be reduced.

Also, since the delay time of the contact point information transmitted and received between the control target and the control unit is known by the synchronization control, temporally accurate control may be performed to improve the reliability of the control.

In addition, even if contact point information is altered due to occurrence of a communication error or the like, this contact point information may be reliably removed, and the reliability is improved to that extent.

### BRIEF DESCRIPTION OF THE DRAWINGS

FIG. 1 is a diagram showing an entire structure of an automatic control system, a contact point information collection and distribution device, and a slave station of the automatic control system of a first embodiment of the present invention;

FIG. 2 is a diagram showing a connection state of main units of the automatic control system shown in FIG. 1;

FIG. 3 is a diagram showing an example of communication by the automatic control system;

FIG. 4 is a diagram showing an entire structure of an automatic control system of a second embodiment;

FIG. 5 is a diagram showing an example of a connection state of main units of the automatic control system shown in FIG. 4;

FIG. 6 is a diagram showing an example of communication by the automatic control system; and

FIG. 7 is a diagram showing an example of a conventional automatic control system.

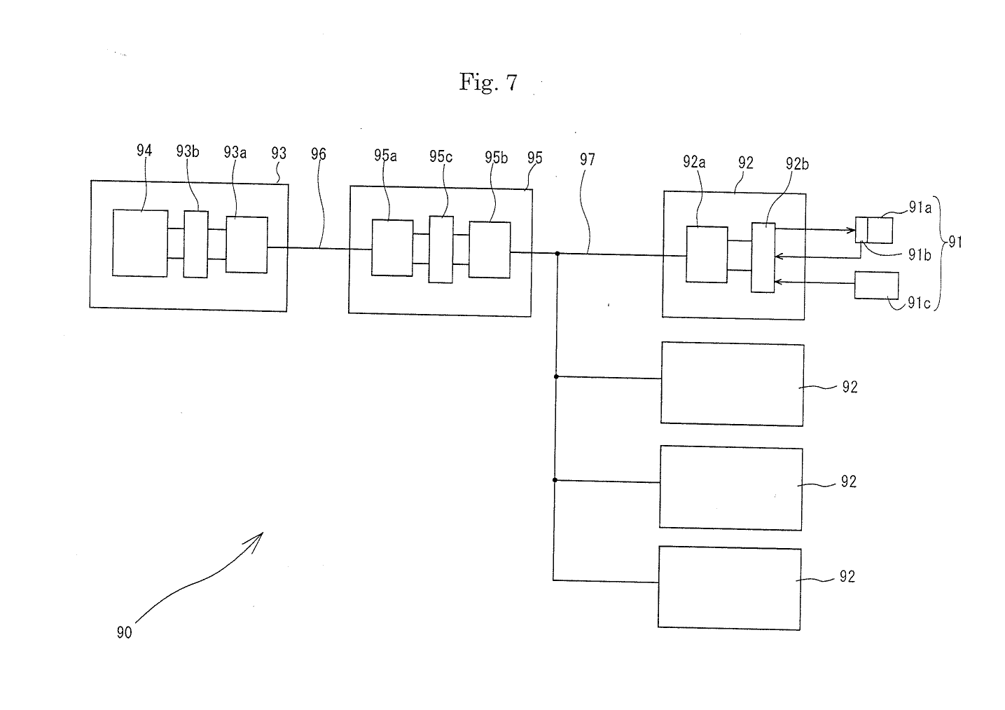

### DETAILED DESCRIPTION OF THE PREFERRED EMBODIMENTS

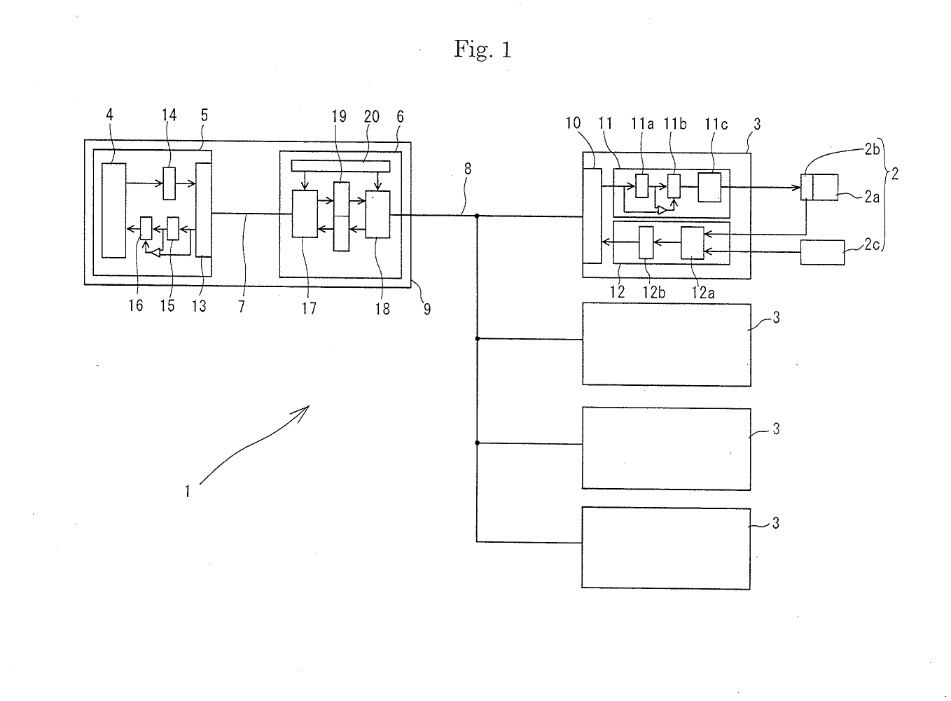

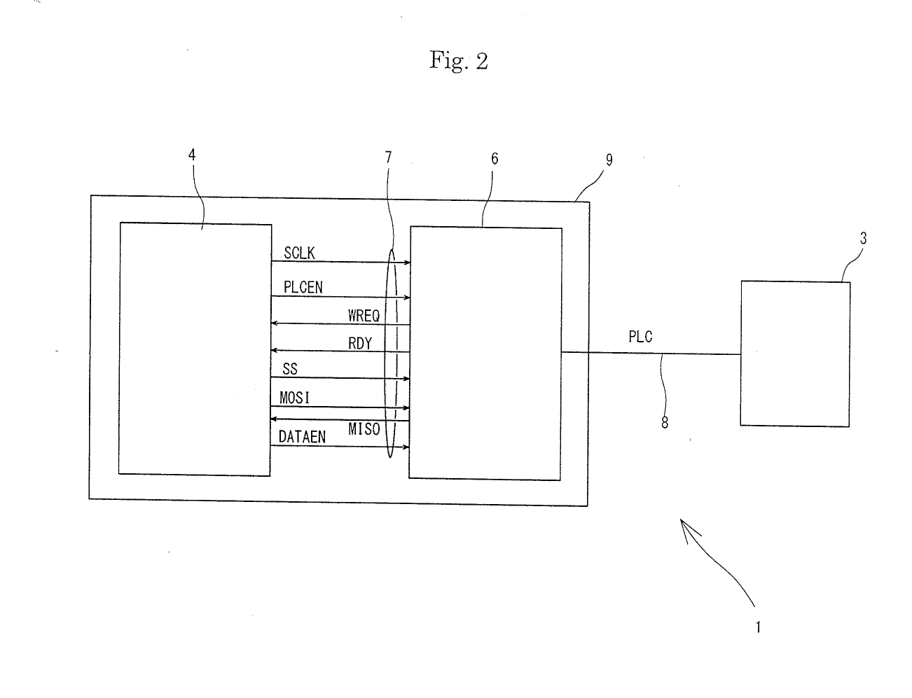

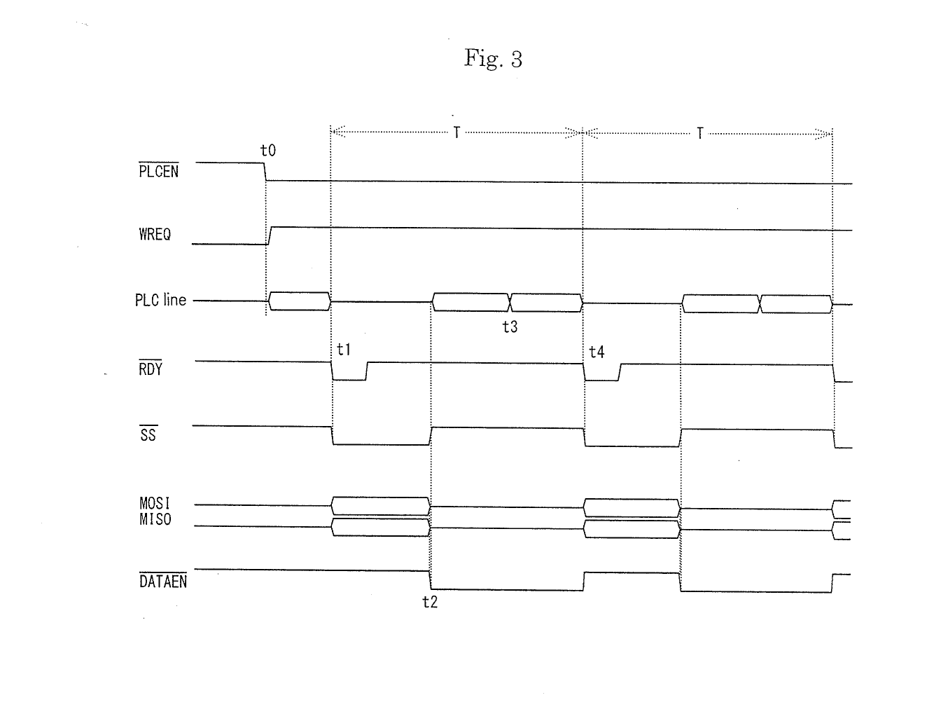

Hereinafter, an automatic control system, a contact point information collection and distribution device, and a slave station of the automatic control system of a first embodiment of the present invention will be described with reference to FIGS. 1 to 3. FIG. 1 shows an entire structure of an automatic control system 1 of a vehicle of the present invention, FIG. 2 shows a connection state, and FIG. 3 is a diagram for describing an operation of the automatic control system.

The automatic control system 1 shown in FIG. 1 is for performing vehicle window opening/closing control, for example, and the reference numeral 2 denotes a control target. Also, the control target 2 at least includes a motor 2a, a rotary encoder 2b provided to the motor 2a, and a switch 2c for performing window operation input and the like.

The reference numeral 3 denotes a slave station connected to the control target 2, the reference numeral 4 denotes a control unit for controlling the control target 2, the reference numeral 5 denotes a master station connected to the control unit 4 (in the present embodiment, it is configured from a one-chip microcomputer in which the control unit 4 is embedded as an arithmetic processing unit and which is connected therein), the reference numeral 6 denotes a contact point information collection and distribution device, the reference numeral 7 denotes a communication line connecting the contact point information collection and distribution device 6 and the master station 5 by SPI, the reference numeral 8 denotes a communication line connecting the contact point information collection and distribution device 6 and the slave station 3 by performing communication according to the token passing method by voltage superimposition communication (PLC) (in the present embodiment, this is a power line, but is referred to as the communication line 8 in the following description), and the reference numeral 9 denotes a control unit (hereinafter “ECU”) of the automatic control system 1 including the master station 5 and the contact point information collection and distribution device 6.

The slave station 3 includes a contact point information transmitting and receiving unit 10, connected to the communication line 8, for performing transmission and reception of contact point information by performing communication according to the token passing method by PLC, an output unit 11 for outputting contact point information received via the contact point information transmitting and receiving unit 10 to the control target 2, and an input unit 12 for inputting contact point information obtained from the control target 2 so as to enable transmission thereof via the contact point information transmitting and receiving unit 10. Also, the output unit 11 includes a first buffer 11a for storing a series of contact point information received via the contact point information transmitting and receiving unit 10, a second buffer 11b for storing the contact point information when the contact point information received from the contact point information transmitting and receiving unit 10 is compared with previous contact point information stored in the first buffer 11a and is found to match, and an output port 11c configured from a drive circuit for amplifying, and outputting to the motor 2a, the contact point information stored in the second buffer 11b. On the other hand, the input unit 12 includes an input port 12a for inputting contact point information from the control targets 2b and 2c, and an input buffer 12b for storing the contact point information input via the input port 12a.

In the present embodiment, an example is shown where two buffers 11a and 11b are provided to the output unit 11 as hardware, and contact point information that is received is compared with a series of contact point information received in the previous communication cycle and is output when it is assumed to be true in the case of matching, but the buffers 11a and 11b may of course be provided to the contact point information transmitting and receiving unit 10. Additionally, in the present embodiment, only the structure of the slave station 3 provided on the driver's seat side of a vehicle is described in detail, but the contact point information transmitting and receiving unit 10, the output unit 11, the input unit 12 and the control target 2 are also provided, although not shown, to the slave stations 3 for the passenger seat and the back seat.

Furthermore, the one-chip microcomputer configuring the master station 5 includes a contact point information transmitting and receiving unit 13 for performing bidirectional serial communication by SPI, a transmission buffer 14 for recording contact point information that is to be transmitted via the contact point information transmitting and receiving unit 13, a first buffer 15 for storing a series of contact point information that is received via the contact point information transmitting and receiving unit 13, and a second buffer 16 for updating and storing the contact point information when the contact point information received in the current communication cycle is compared with a series of previous contact point information stored in the first buffer 15 and is assumed to be true in the case of matching.

Moreover, in the present embodiment, the main unit of the master station 5 is the contact point information transmitting and receiving unit 13, and this contact point information transmitting and receiving unit 13 is connected to the control unit 4 via the buffers 14 to 16. Accordingly, the control unit 4 is connected to the master station 5 while being formed inside the one-chip microcomputer configuring the master station 5. Also, the buffers 14 to 16 are all memories that can be accessed by the arithmetic processing unit of the one-chip microcomputer, and are storage areas managed by programs that can be executed by the control unit 4, and these buffers 14 to 16 may be configured from registers in the control unit 4, or may be configured by hardware such as memory elements.

The contact point information collection and distribution device 6 includes contact point information transmitting and receiving units 17 and 18 that are connected to the communication lines 7 and 8, respectively and transmit and receive a series of contact point information in a predetermined communication cycle, a relay buffer 18, configured from a dual port memory or the like, for storing the contact point information which has been transmitted and received, and a communication cycle adjustment unit 20 for synchronizing the communication cycle of each of the communication lines 7 and 8 with control by the control unit. Additionally, in the present embodiment, the contact point information transmitting and receiving unit 17 performs bidirectional communication by SPI via the communication line 7, and the contact point information transmitting and receiving unit 18 performs communication according to the token passing method by PLC via the communication line 8. The relay buffer 19 includes separate areas for storing the contact point information from the master station 5 and the contact point information from the slave station 3, and the sizes of the areas are preferably settable according to the contents of the series of contact point information to be handled so as to increase the versatility.

As shown in FIG. 2, to perform bidirectional serial communication by SPI at the connection portion of the master station 5 and the contact point information collection and distribution device 6, the communication line 7 includes an operation clock signal SCLK, a transfer permission signal PLCEN for permitting voltage superimposition on the communication line 8, a transfer start timing signal SS of the contact point information collection and distribution device 6 and a transfer completion signal DATAEN indicating completion of transmission and reception of a series of contact point information by the master station 5 that are output from the side of the master station 5, and an operation enabled signal WREQ indicating an operation enabled state and a transfer preparation completion signal RDY that are output from the side of the contact point information collection and distribution device 6, and SPI bus lines MOSI and MISO for transmitting and receiving bidirectional serial data in the form of a bit stream.

In the following, a method of maintaining synchrony of pieces of contact point information transmitted and received among the master station 5, the contact point information collection and distribution device 6, and the slave station 3 will be described with reference to FIG. 3.

When the master station 5 outputs a transfer permission signal PLCEN indicating permission of data transfer by PLC using the communication line 8 to the contact point information collection and distribution device 6 at time t0, the communication cycle adjustment unit 20 of the contact point information collection and distribution device 6 outputs an operation enabled signal WREQ to the master station 5 and, at the same time, causes the contact point information transmitting and receiving unit 18 to start issuing of a token signal by PLC to thereby collect contact point information of each slave station 3, and to receive the contact point information input to the input unit of each slave station 3 by PLC, and causes the buffer 19 to store the latest contact point information collected from each slave station 3. At this time, the latest contact point information that is input may be made stable by providing the buffer 12b to the input unit 12. Then, at time t1, a transfer preparation completion signal RDY is output.

Next, the master station 5 checks that the transfer preparation completion signal RDY is output, and outputs a transfer start timing signal SS to the contact point information collection and distribution device 6 and, at the same time, performs bidirectional serial communication by SPI with the contact point information collection and distribution device 6 to thereby perform transmission and reception of a series of contact point information in a bidirectional manner. At this time, a series of contact point information from each slave station 3 received by the contact point information transmitting and receiving unit 13 is compared with the previous contact point information recorded in the first buffer 15 and only the contact point information that matches is written to the second buffer 16, and thus, information in which an error is included due to an external disturbance such as a noise does not enter the second buffer 16. On the other hand, since the contact point information to be distributed by the master station 5 to each slave station 3 is also transmitted via the buffer 14, the latest contact point information may be made stable. Then, the master station 5 outputs a transfer completion signal DATAEN at time t2 when transmission and reception of all of a series of contact point information to be collected and distributed has been completed.

The communication cycle adjustment unit 20 of the contact point information collection and distribution device 6 checks that the latest contact point information from the master station 5 is recorded in the relay buffer 19 by checking that the transfer completion signal DATAEN is output from the master station 5, and causes the contact point information transmitting and receiving unit 18 to start issuing of a token signal by PLC to transmit a series of contact point information received from the master station 5 to the slave station 3 by PLC.

Furthermore, from time t3 when the latest contact point information from the master station 5 is distributed to each slave station 3 by using the contact point information transmitting and receiving unit 18, the communication cycle adjustment unit 20 causes the contact point information of each slave station 3 to be collected, receives the contact point information input to the input unit of each slave station 3 by PLC, and causes the latest contact point information collected to be stored in the buffer 19. Then, at time t4, a transfer preparation completion signal RDY is output to the side of the master station 5. Then, exchange of signals from time t1 to time t4 is repeated, and collection and distribution of a series of contact point information may be performed in one communication cycle T with all the units on the automatic control system 1 being in synchronization with the transfer preparation completion signal RDY.

Also, the control unit 4 of the master station 5 may execute automatic control programs such as a sequence program according to the communication cycle T, and may perform automatic control according to the state of each control target 2. Since the communication lines 7 and 8 both perform transmission and reception of a series of contact point information in a predetermined communication cycle, the communication cycle T may reliably be made to have a constant length and the automatic control by the control unit 4 may be completely synchronized with this communication cycle T.

Accordingly, even in the case of performing communication according to a plurality of protocols and over a plurality of communication lines 7 and 8, since the contact point information of the control target 2 is input to the control unit 4 being delayed by multiples of the known communication cycle T and the contact point information output from the control unit 4 is output to each control target 2 being delayed by multiples of the known communication cycle T, the control unit 4 may accurately control the control target 2 while taking these delay times into account.

The control unit 4 performs automatic control by performing collection and distribution of the contact point information in the communication cycle T that is generally slower than the operation speed of the control unit 4, and thus, a high-speed operation is not necessary, and execution by an inexpensive one-chip microcomputer is enabled. Also, since the control unit 4 performs automatic control that is synchronous with the communication cycle T, other types of signal processing may be performed using the time when the automatic control processing is not performed.

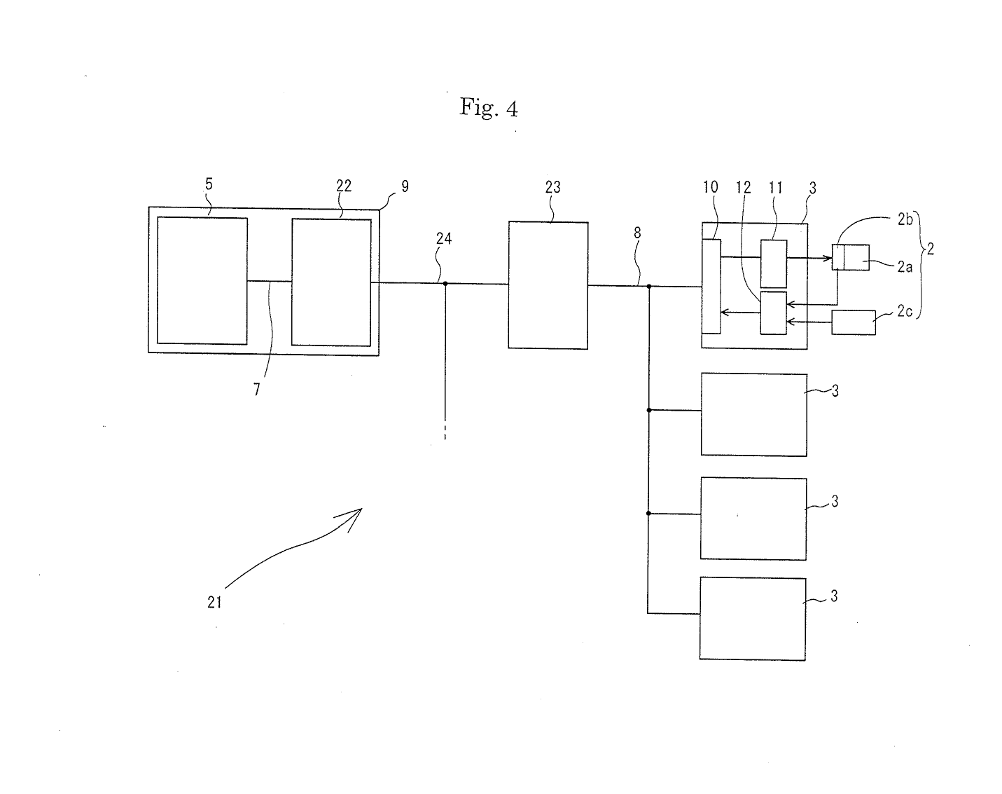

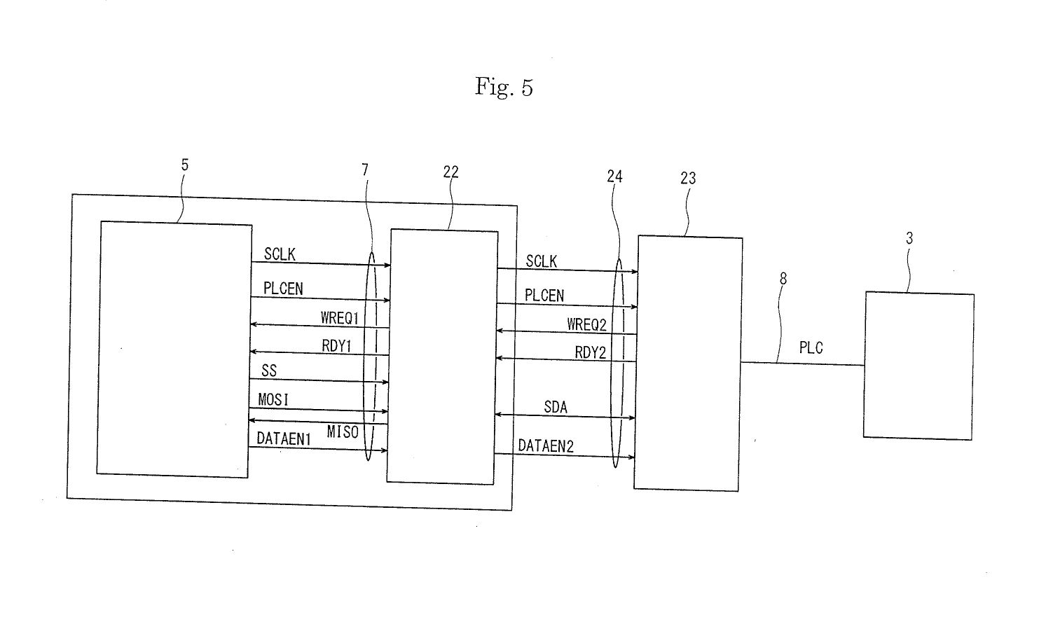

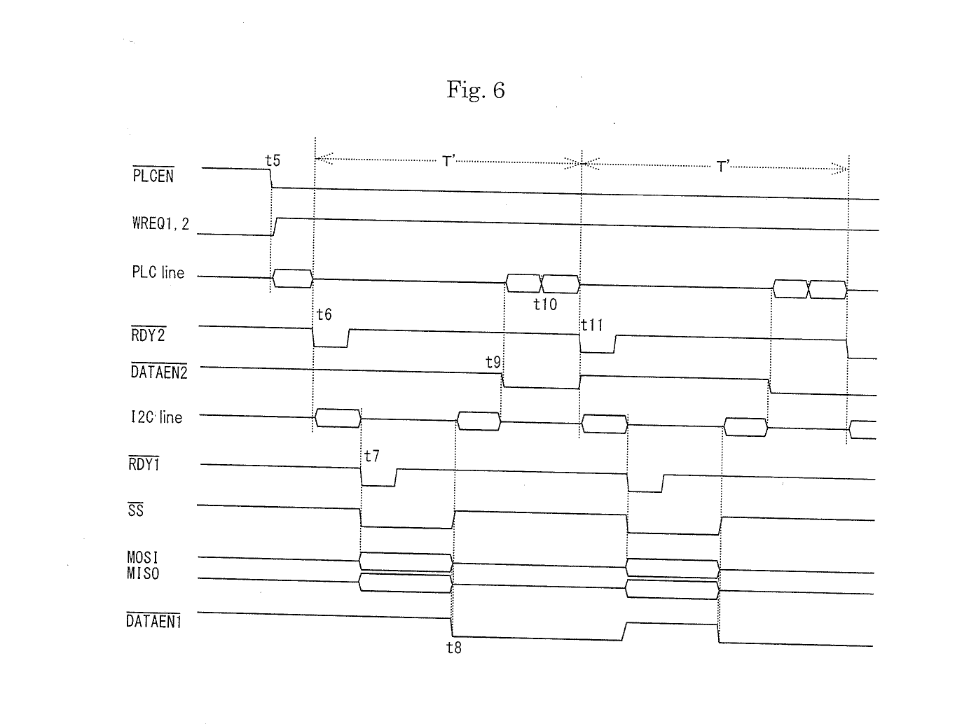

FIG. 4 is a diagram showing a structure of an automatic control system 21 of a second embodiment, FIG. 5 is a diagram showing a connection state of main units, and FIG. 6 is a diagram showing an example of communication. In FIGS. 4 to 6, portions denoted with the same reference numerals as in FIGS. 1 to 3 are the same or equivalent portions, and detailed description thereof is omitted.

In FIG. 4, the reference numerals 22 and 23 denote upper and lower contact point information collection and distribution devices, and the reference numeral 24 denotes a communication line connecting the upper and lower contact point information collection and distribution devices 22 and 23. In the present embodiment, serial communication by a plurality of communication lines 7, 24 and 8 is performed in three hierarchical stages, and in the intermediate stage where the communication line 24 is used, serial communication by I2C is performed, for example. Thus, a plurality of contact point information collection and distribution devices 23 may be provided, and the amount of data of the contact point information handled by the lower contact point information collection and distribution device 23 may thereby be reduced, but this is omitted in the drawing for the sake of simplicity of the description.

As shown in FIG. 5, the communication line 7 connecting the master station 4 and the upper contact point information collection and distribution device 22 includes an operation clock signal SCLK, a transfer permission signal PLCEN, a transfer start timing signal SS of the contact point information collection and distribution device 22, and a transfer completion signal DATAEN1, and an operation enabled signal WREQ1 indicating an operation enabled state and a transfer preparation completion signal RDY1 that are output from the side of the contact point information collection and distribution device 22, and SPI bus lines MOSI and MISO for transmitting and receiving bidirectional serial data.

On the other hand, the communication line 24 connecting the upper and lower contact point information collection and distribution devices 22 and 23 includes an operation clock signal SCLK, a transfer permission signal PLCEN, and a transfer completion signal DATAEN2 indicating completion of transfer of a series of contact point information to be transferred from the contact point information collection and distribution device 22 to the contact point information collection and distribution device 23, and an operation enabled signal WREQ2 indicating an operation enabled state and a transfer preparation completion signal RDY2 indicating completion of preparation of contact point information that is to be transmitted from the contact point information collection and distribution device 23 to the contact point information collection and distribution device 22 that are output from the contact point information collection and distribution device 23, and an I2C bus line SDA for transmitting and receiving bidirectional serial data.

In the following, an operation of the second embodiment will be described with reference to FIG. 6. When the master station 5 outputs, at time t5, a transfer permission signal PLCEN to the contact point information collection and distribution devices 22 and 23, the contact point information collection and distribution devices 22 and 23 output operation enabled signals WREQ1 and WREQ2, and at the same time, the contact point information collection and distribution device 23 performs collection of the contact point information of each slave station 3 by performing communication by PLC using the communication line 8, and then, outputs a transfer preparation completion signal RDY2 at time t6. The upper contact point information collection and distribution device 22 checks the transfer preparation completion signal RDY2, performs collection of the contact point information from the contact point information collection and distribution device 23 by performing communication by I2C using the communication line 24, and outputs a transfer preparation completion signal RDY1 at time t7.

Next, the master station 5 checks that the transfer preparation completion signal RDY1 is output, and performs bidirectional transmission and reception of a series of contact point information by performing bidirectional serial communication by SPI with the upper contact point information collection and distribution device 22. Then, the master station 5 outputs a transfer completion signal DATAEN1 at time t8 when transmission and reception of all of a series of contact point information that is to be collected and distributed has been completed.

Also, the upper contact point information collection and distribution device 22 checks that reception of the latest contact point information from the master station 5 has been completed by checking that the transfer completion signal DATAEN1 is output by the master station 5, transmits a series of contact point information from the master station 5 to the lower contact point information collection and distribution device 23 by performing communication by I2C using the communication line 24, and at time t9 when all of a series of contact point information from the master station 5 has been transferred, outputs a transfer completion signal DATAEN2 to the contact point information collection and distribution device 23.

Furthermore, the lower contact point information collection and distribution device 23 distributes the latest contact point information from the master station 5 to each slave station 3 by using the communication line 8 from time t9 when output of the transfer completion signal DATAEN1 from the contact point information collection and distribution device 22 is confirmed, performs collection of the contact point information of each slave station 3 and receives the contact point information input to the input unit of each slave station 3 by PLC from time t10 when the process mentioned above is completed, and outputs a transfer preparation completion signal RDY2 at time t11. Then, exchange of signals from time t6 to time t11 is repeated, and collection and distribution of a series of contact point information may be performed in one communication cycle T′ with all the units on the automatic control system 21 being in synchronization with the transfer preparation completion signals RDY1 and 2.

As in the present embodiment, by performing collection and distribution of the contact point information in several hierarchical stages by using a plurality of communication lines 8 and 24, even in the case a series of contact point information with a large amount of data is to be collected and distributed, since the amount of data of the contact point information to be collected and distributed by using the lower communication line 8 may be divided and reduced, the communication cycle T′ may be made shorter as a result of reducing the amount of data of the contact point information that is to be handled, even if the communication speed of the communication line 8 is relatively low.

Even when the structure of the communication lines 7, 8 and 24 configuring the automatic control system 21 is complicated as in the present embodiment, error check may be performed at once at the stations on both ends (the master station 5 and the slave station 3) by double collation, and an error due to communication failure may be reliably removed, and simple and highly reliable collection and distribution of the contact point information across a plurality of communication lines may be performed.

What is claimed is:

1. An automatic control system including a slave station that is connected to a control target, a master station that is connected to a control unit for controlling the control target, a contact point information collection and distribution device, existing between the master station and the slave station, that collects and distributes a series of contact point information communicated at a predetermined communication cycle, and a plurality of communication lines that connect between the master station and the slave station via at least one contact point information collection and distribution device, wherein the contact point information collection and distribution device performs collection and distribution of the series of contact point information in synchronization with all the communication lines under the control of the control unit, and wherein the control unit compares contact point information collected via the contact point information collection and distribution device with past contact point information collected in a previous communication cycle and assumes as true in a case of matching, and performs control by true contact point information.

2. The automatic control system according to claim 1, wherein the control unit includes a first buffer for storing the contact point information received in the previous communication cycle, and a second buffer for updating and storing the contact point information when the contact point information that is received in the current communication cycle is compared with the previous contact point information stored in the first buffer and is assumed to be true in the case of matching, and the control target is to be controlled based on the contact point information stored in the second buffer.

3. The automatic control system according to claim 1, wherein the contact point information collection and distribution device includes contact point information transmitting and receiving units existing between the slave station and the master station and being connected to the communication lines and being for transmitting and receiving a series of contact point information in a predetermined communication cycle, a relay buffer for storing contact point information which has been transmitted or received, and a communication cycle adjustment unit for synchronizing a communication cycle of each communication line with control by the control unit.

4. The automatic control system according to claim 1, wherein the slave station includes an input unit, connected to a control target, for inputting contact point information obtained from the control target, a contact point information transmitting and receiving unit for transmitting and receiving a series of contact point information in a predetermined cycle by transmitting the contact point information input from the input unit to a communication line and receiving, from a communication line, contact point information from a master station connected to a control unit for controlling the control target, and an output unit for outputting the contact point information to the control target when the contact point information received in the communication cycle is compared with a series of contact point information received in a previous communication cycle and is assumed to be true in a case of matching.
